(19) United States
(12) Patent Application Publication
(10) Pub. No.: US 2020/0240366 A1
(43) Pub. Date: Jul. 30, 2020

(54) FLUID VALVE AND METHOD FOR CONTROLLING THE SUPPLY OF FLUID

(71) Applicant: Vitesco Technologies GMBH, Hannover (DE)

(72) Inventors: Harry Schüle, Neunburg V. Wald (DE); Stefan Schuster, Regensburg (DE); Janos Kerekgyarto, Regensburg (DE)

(73) Assignee: Vitesco Technologies GMBH, Hannover (DE)

(21) Appl. No.: 16/846,334

(22) Filed: Apr. 11, 2020

Related U.S. Application Data
(63) Continuation of application No. PCT/EP2018/077389, filed on Oct. 9, 2018.

(30) Foreign Application Priority Data
Oct. 12, 2017 (DE) 10 2017 218 267.9

(51) Int. Cl. F02M 21/02; B05B 1/30; F02M 61/20; F02M 61/18; F02M 61/04; F02M 51/06

(52) U.S. Cl. CPC F02M 21/0254; B05B 1/3053; F02M 21/0275; F02M 61/20; F02M 21/0263; F02M 2200/30; F02M 61/042; F02M 21/0272; F02M 51/0614; F02M 51/0667; F02M 61/1886

(57) ABSTRACT

A fluid valve which has a first valve assembly, having a valve needle, and an electromagnetic actuating device is disclosed. The electromagnetic actuating device has an armature, which is coupled to the valve needle, and a pole piece. The armature has on an armature stop side which is opposite the pole piece an armature stop surface, and the pole piece has on a pole piece stop side which is opposite the armature a pole piece stop surface. For advantageous refinement, it is proposed that the first valve assembly has a deformable first ring element and a deformable second ring element, wherein, in a view along the longitudinal central axis, an inner contour of the first ring element extends outside an outer contour of the second ring element. The invention also relates to a method for controlling the supply of fluid by means of a fluid valve according to the invention.

### CROSS REFERENCE TO RELATED APPLICATIONS

This application claims the benefit of PCT Application PCT/EP2018/077389, filed Oct. 9, 2018, which claims priority to German Application DE 10 2017 218 267.9, filed Oct. 12, 2017. The disclosures of the above applications are incorporated herein by reference.

### TECHNICAL FIELD

The present invention relates to a fluid valve, in particular gas valve, which includes a valve housing extending from a fluid inlet to a fluid outlet along a longitudinal central axis and includes at least one first valve assembly, wherein the first valve assembly has a valve needle and an electromagnetic actuating device, wherein the valve needle is movable in a cavity of the valve housing along the longitudinal central axis, wherein the electromagnetic actuating device has an armature, which is coupled to the valve needle, and a pole piece, which is coupled to the valve housing, wherein the armature has on an armature stop side which is opposite the pole piece an armature stop surface, and the pole piece has on a pole piece stop side which is opposite the armature a pole piece stop surface.

### BACKGROUND

The proportion of gas-operated vehicles will increase more and more over the coming years. The extra charge for the additional gas operation, however, is an important sales point for the acceptance of the customers, and for this reason the system should be as simple as possible. The system configuration of a modern-day gas system generally provides a gas store, shut-off valves, temperature and pressure sensors, a pressure reducer or pressure regulator, gas injection valves and a control unit for the additional components.

In natural-gas vehicles, the fuel is generally stored in bottles at pressures of up to 200 bar. For this reason, it is necessary to have a pressure reducer which reduces gas from the high bottle pressure to a low rail pressure at the inlet of the injection valves. This low rail pressure is generally 2-20 bar, according to:
the injection location for intake pipe injection (PI, port injection) or direct injection (DI) into the combustion chamber,
the properties of the injection valve, such as magnetic forces, available electrical boundary conditions of current and voltage, and
of course the pressure level of the gas, which determines the forces on the movable parts, such as the needle.

In the case of a gas injection valve, however, the limits of possible throughflow are very quickly reached since, with a gas, a larger cross section is required than in the case of a liquid injection valve. The required cross section comes at the expense of an increased stroke of the needle or of a plate. Limits are again reached with a relatively large diameter of this actuator since the gas forces consequently increase. The larger the spacing of the actuator to the coil as a result of an increased stroke, the smaller the magnetic forces, by way of which the actuator can be lifted, become. This means that, for a desired throughflow, matching of the stroke of the needle together with the magnetic forces is necessary.

However, the large strokes of the needle or of the armature of such an injection valve also lead to large accelerations of the needle as soon as this has been lifted from the seat and the gas forces acting counter to the movement direction are reduced. An additional factor is that the magnetic forces become stronger and stronger the closer the armature and/or needle comes to the pole piece of the electromagnet. The metallic needle will thus impact against the metallic pole piece with full force and in an unbraked manner. It has been found that, in this way, a gas injection valve, which has to open and close several hundred million times over its service life, can be destroyed at the impact location.

A generic fluid valve is known from EP 2 602 476 A1 and from EP 2 378 106 A1.

### SUMMARY

Against this background, the first aspect of the invention, according to example embodiments, is based on the object of advantageously further developing a fluid valve. In particular, it is sought for the above-described disadvantages to be partly or completely avoidable as a result.

According to a second aspect, an example embodiments relates to a method for controlling the supply of fluid, such as gas, into a combustion chamber in an internal combustion engine. In known methods of said type, the above-described difficulties also arise.

The second aspect is based on further developing a known method for controlling the supply of fluid. In particular, in this case, it is also sought for the above-described disadvantages to be at least partly or completely avoidable.

According to the first aspect, example embodiments include the first valve assembly having a deformable first ring element and a deformable second ring element, and that, in a view along the longitudinal central axis, an inner contour of the first ring element extends outside an outer contour of the second ring element.

The fluid valve or gas valve may be a gas injection valve for controlling the supply of gas into a combustion chamber of an internal combustion engine of a motor vehicle or the like. The armature stop surface and the pole piece stop surface may jointly limit axial movement of the valve needle directed to the fluid inlet, wherein the contact between the armature stop surface and the pole piece stop surface takes place when the valve needle is in an opening end position, that is to say in a position such that the first valve assembly allows the passage of fluid (such as gas).

If the electromagnetic actuating device is activated by means of an electric voltage, current flows through a coil of the electromagnet, which leads to the armature being attracted in an electromagnetic manner by the pole piece in an axial direction such that, when a particular electromagnetic force is exceeded, the valve needle is moved in the direction to the pole piece counter to the force of the restoring spring. From a certain proximity of the armature stop surface to the pole piece stop surface, which is opposite the latter, the deformable ring elements are deformed, whereby the approach speed is braked not in an abrupt manner but in a gradual manner. The deceleration results from the energy required for deforming the ring elements. In an embodiment, a maximum approach is achieved if the armature stop surface and the pole piece stop surface make contact with one another. As a result of the residual speed reduced by the deformations, the impact force of the armature stop surface against the pole piece stop surface is reduced and the impact is therefore dampened, and so the deformable ring elements may also be referred to as damping elements.

In an expedient configuration, the fluid valve is a gas injection valve. For damping a movement of the armature stop surface in the direction toward the pole piece stop surface, a gas cushion is able to be enclosed between the armature stop surface and the pole piece stop surface by means of the ring elements, the gas cushion being delimited in a radial direction by the first ring element and the second ring element.

In other words, in the arrangement of two deformable ring elements, while each ring element makes contact with the stop surface opposite it, a certain quantity of the fluid or of the gas is enclosed between the ring elements. The continued approach of the two stop surfaces, that is to say the armature stop surface and the pole piece stop surface, to one another results in the fluid or gas volume acting like a cushion which advantageously brings about damping as a technical effect during the mutual approach. If a gas is used as a fluid, pneumatic damping is achieved. This too contributes to an approach up to the mutual contact of the two stop surfaces that is slowed down in comparison with a conventional fluid valve. The two above-described effects are consequently superimposed and intensified such that a sharp impulse is avoided in a particularly effective manner by prior, firstly gradual, that is to say non-abrupt, braking of the moved actuator (that is to say of the armature and the valve needle) with the first contact between the armature stop surface and the pole piece stop surface. If this is related to the valve needle movement, improved needle damping is consequently advantageously achieved as a technical effect. The fact that the first contact takes place with only a reduced residual speed means that a reduction in noise generation is also achieved when the contact takes place.

There are numerous possibilities concerning different configurations and refinements:

In one configuration, the first and second ring elements are formed by a first sealing lip and a second sealing lip of an elastomer ring. In this configuration, the cross section of the elastomer ring, for forming the sealing lips, expediently deviates from a circular shape. Both sealing lips are projections of the elastomer ring that point in the direction of the armature stop surface or in the direction of the pole piece stop surface. Expediently, the first sealing lip may extend around the second sealing lip. The elastomer ring, in particular on its side facing away from the sealing lips, is received in a ring groove of the armature or of the pole piece. Advantageously, the first and second ring elements may in this way be arranged particularly easily on the pole piece or armature during the production of the valve.

In another configuration, on the armature stop side or on the pole piece stop side, a first ring groove is formed in the armature or in the pole piece, in which first ring groove the first ring element is arranged. Moreover, on the armature stop side or on the pole piece stop side, a second ring groove is formed in the armature or in the pole piece, in which second ring groove the second ring element is arranged. If a gap is formed between the armature stop surface and the pole piece stop surface, the first ring element projects axially from the first ring groove and the second ring element projects axially from the second ring groove. In this configuration, the ring elements may be produced in a particularly simple manner and/or with long-term stability. It is possible to achieve a particularly large gas cushion and/or low production tolerances in the region of the working gap between the armature and pole piece stop sides. In one refinement of this embodiment, the first and the second ring elements each have a circular cross section.

A state in which there is no contact between the armature stop surface and the pole piece stop surface, that is to say in which a gap is formed between the armature stop surface and the pole piece stop surface, may be characterized for example in that the electromagnetic actuating device is in a deactivated state. In the deactivated state, the pole piece exerts no magnetic force of attraction on the armature. A state in which the valve needle is at a distance from its opening end position, and in particular a state in which the first valve assembly is in a closed position, so that no passage of fluid is possible, may be involved. Axial projection of the first ring element and the second ring element from their respective ring grooves means that the ring element protrudes beyond the stop surface laterally adjoining said respective ring groove (that is to say armature stop surface or pole piece stop surface) in a direction oriented along the longitudinal central axis.

Provision may be made for the formation of the first ring groove and the second ring groove on the armature stop side proceeding from the armature stop surface or for the formation of the first ring groove and the second ring groove on the pole piece stop side proceeding from the pole piece stop surface or for the formation of the first ring groove on the armature stop side proceeding from the armature stop surface and the second ring groove on the pole piece stop side proceeding from the pole piece stop surface or for the formation of the second ring groove on the armature stop side proceeding from the armature stop surface and the first ring groove on the pole piece stop side proceeding from the pole piece stop surface. By way of these variants, in each case the described effects and advantages are achieved. In an expedient refinement, the armature stop surface and/or the pole piece stop surface are/is a planar surface apart, possibly, from the ring groove(s). Preferably, the armature stop surface and the pole piece stop surface are parallel to one another.

It may be the case that, in a view along the longitudinal central axis, the inner contour of the first ring element, in particular along the entire circumference leading around the longitudinal central axis, is spaced apart from the outer contour of the second ring element perpendicular to the circumferential direction. The fluid valve is intended for injection of gas into a combustion chamber of an internal combustion engine. By means of the dimensioning of the intermediate spacing, it is possible for the size of the fluid cushion and thus a pneumatic damping effect to be influenced. Provision is made for the first ring groove and the second ring groove, in a view along the longitudinal central axis, to be arranged so as to be concentric with one another. Firstly, this promotes a symmetrical force distribution. Furthermore, this proves to be advantageous for simple and thus inexpensive production. Accordingly, provision may be made for the first ring element and the second ring element, in a view along the longitudinal central axis, to be arranged so as to be concentric with one another. Provision may be made for the first ring groove and/or the second ring groove to be of circular or polygonal or multi-cornered, in particular square, shape. Accordingly, provision may be made for the first ring element and/or the second ring element to be of circular or polygonal or multi-cornered, in particular square, shape. It may be the case that the first ring element is placed or injected into the first ring groove or is fastened therein in some other manner, and/or that the second ring element is placed or injected into the second ring groove or is fastened therein in some other manner. This offers advantages with regard to production and usage characteristics. Provision may be made for the first ring element and the second ring element to be produced from elastically deformable material. Provision may be made for the first ring element and the second ring element to be produced from plastic, rubber, elastomer or the like. The first ring element and the second ring element may be of similar design, so that the risk of inadvertent swapping may be avoided during the assembly. It may be the case that the armature stop surface and/or the pole piece stop surface extend(s) perpendicular to the longitudinal central axis.

In an example embodiment, it is provided that, with respect to a valve longitudinal direction, the pole piece is arranged between the armature and the fluid inlet such that the armature stop surface and the pole piece stop surface limit axial movement of the valve needle in a direction directed to the fluid inlet. The first valve assembly may have a valve seat which is coupled axially to the valve housing or is formed on the valve housing and which limits axial movement of the valve needle in a direction directed away from the fluid inlet. Consequently, the first valve assembly may be a valve assembly of the so-called inwardly opening type. It may be the case that the first valve assembly has a restoring spring, which is in particular a cylindrical compression spring, one of whose longitudinal spring ends is supported directly or indirectly against the valve housing, and whose second longitudinal spring end is supported directly or indirectly against the valve needle, with the result that the restoring spring subjects the valve needle to spring force in the direction to the fluid outlet. An expedient configuration is seen in that the fluid valve includes a second valve assembly, which, with respect to a fluid passage direction of the fluid valve, is arranged downstream of the first valve assembly, in that a fluid outlet region of the first valve assembly is fluidically connected to a fluid inlet region of the second valve assembly, and in that the second valve assembly includes a separate valve needle and a separate restoring spring, wherein the valve needle of the second valve assembly is movable, in particular from a closed position into an open position, in a cavity of the valve housing along the longitudinal central axis counter to the spring force of the restoring spring of the second valve assembly. Consequently, the second valve assembly may be a passive valve assembly of the so-called outwardly opening type. In such a fluid valve, the first valve assembly may serve as an “active” valve assembly for controlling the second valve assembly. Provision may advantageously be made for the second valve assembly to be designed to be insensitive to high temperatures (which prevail in a combustion chamber of an internal combustion engine).

According to the second aspect, for advantageous refinement of a method for controlling the supply of fluid, such as gas, the electromagnetic actuating device is activated such that the armature, for opening the fluid valve, is attracted in an electromagnetic manner by the pole piece, whereby the first deformable ring element and the second deformable ring element are increasingly deformed. With regard to the effects and advantages, reference is made to the description above. The method may advantageously be refined in that the armature is attracted by the pole piece until the armature stop surface abuts against the pole piece stop surface.

### BRIEF DESCRIPTION OF THE DRAWINGS

Below, the present invention will be discussed further with reference to the preferred exemplary embodiments shown in the appended figures. In the figures, in detail:

FIG. 1 shows a longitudinal section through a fluid valve according to a first example embodiment, wherein the first valve assembly for the passage of fluid is shown in an open state;

FIG. 2 shows an enlarged illustration of detail II from FIG. 1;

FIG. 3 shows, perspectively and partially cut away, the armature shown in FIG. 2;

FIG. 4 shows the image detail shown in FIG. 2, wherein however, in deviation from FIG. 2, the first valve assembly is in a closed state;

FIG. 5 shows, in a detail, a second example embodiment of a fluid valve, and

FIG. 6 shows, in a detail, a third example embodiment of a fluid valve.

### DETAILED DESCRIPTION

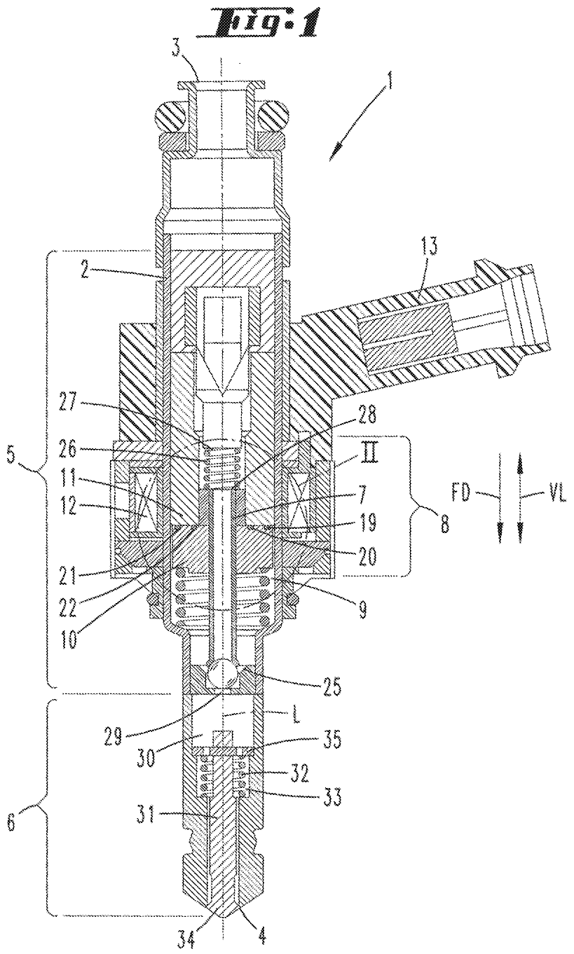

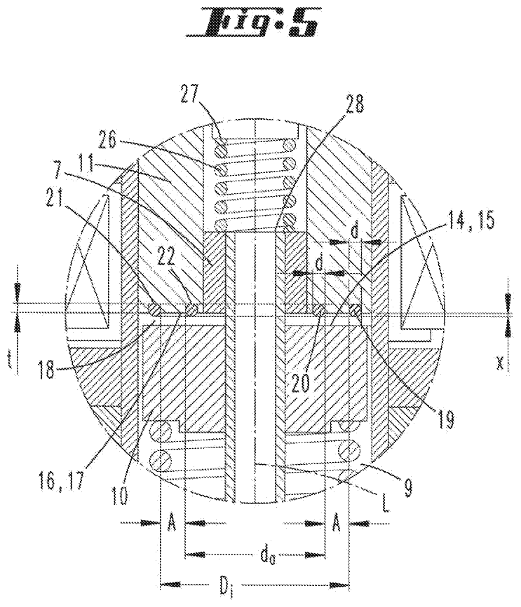

A first example embodiment of a fluid valve 1 is presented with reference to FIGS. 1 to 4. In the example, the fluid valve is a gas injection valve, which may serve for controlling the supply of gas into a combustion chamber of an internal combustion engine for a motor vehicle. The fluid valve 1 includes a valve housing 2, which has multiple parts in the example and extends from a fluid inlet 3 to a fluid outlet 4 of the fluid valve 1 along a longitudinal central axis L. In the example, the fluid valve 1 includes a first valve assembly 5 and a second valve assembly 6, which, with respect to a fluid passage direction FD, adjoins the first valve assembly downstream. The first valve assembly 5 has a valve needle 7 and an electromagnetic actuating device 8. The valve needle 7 is movable in a cavity 9 of the valve housing 2 along the longitudinal central axis L, that is to say in an axial direction. The electromagnetic actuating device 8 has an armature 10, a pole piece 11 and a coil 12. The armature 10 is fastened to the valve needle 7 such that, between the components, no axial relative movement is possible. The pole piece 11 is fixed in the valve housing 2 such that, between the valve housing 2 and the pole piece 11, no axial relative movement is possible. The coil 12 is likewise fixed in the valve housing 2 so as to be immovable relative to the latter, and, by means of an electrical connection 13 for activating the actuating device 8, an electric voltage may be applied to the coil, such that electric current flows through the coil 12. As also shown in enlarged form for example in FIG. 4, the armature 10 forms on its armature stop side 14 which is opposite the pole piece 11 an armature stop surface 15. The pole piece 11 forms on its pole piece stop side 16 which is opposite the armature 10 a pole piece stop surface 17. In FIG. 2, which shows an open position (that is to say an operating state in which fluid is allowed to pass through) with respect to the first valve assembly 5, the armature stop surface 15 and the pole piece stop surface 17 are supported against one another. In deviation therefrom, in FIG. 4, which shows a closed position (that is to say an operating state in which no fluid is allowed to pass through) of the first valve assembly 5, a gap 18 which is filled with fluid and has a limited axial extent is formed between the armature stop surface 15 and the pole piece stop surface 17. The gap 18 is bordered directly by the armature stop surface 15 and by the pole piece stop surface 17.

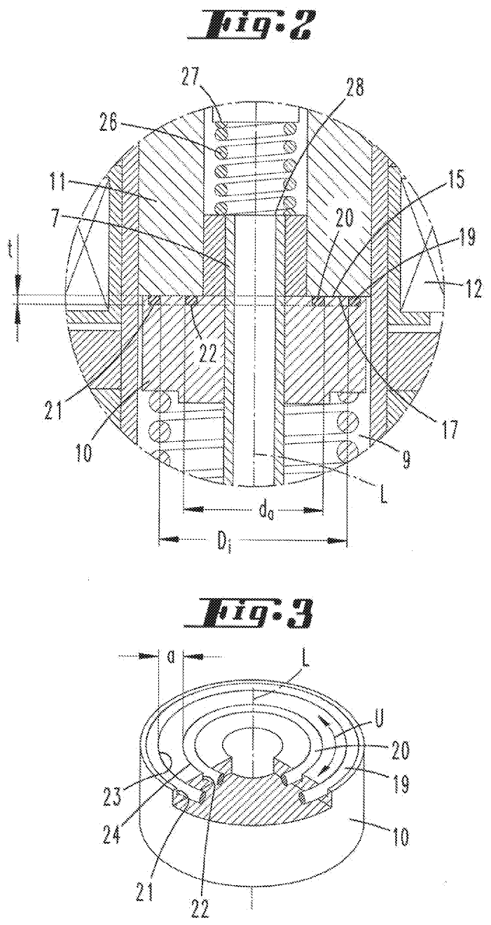

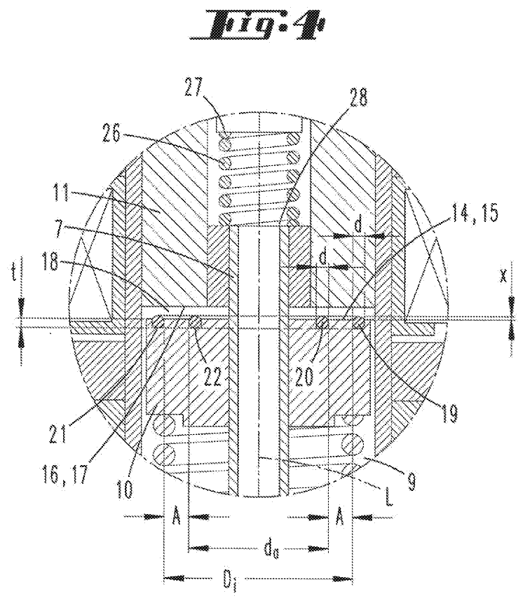

The first valve assembly 5 includes a deformable first ring element 19 and a deformable second ring element 20. In the example, the first ring element 19 is arranged in a first ring groove 21, which is formed on the armature stop side 14, and the second ring element 20 is arranged in a second ring groove 22, which is likewise formed on the armature stop side 14. The configuration, in particular with regard to the shown cross section of the ring elements 19, 20 and to the depth of the ring grooves 21, 22, is selected such that, if (as shown in FIG. 4) the gap 18 is present, the first ring element 19 projects axially from the first ring groove 21 beyond the armature stop surface 15 in the direction to the pole piece 11 and the second ring element 20 projects from the second ring groove 22 beyond the armature stop surface 15 in an axial direction to the pole piece 11. FIG. 3 illustrates that, in a view along the longitudinal central axis L, an inner contour 23 of the first ring element 19 extends outside an outer contour 24 of the second ring element 20. In the example, the ring elements 19, 20 and the ring grooves 21, 22 each extend in a circular manner. The inner contour 23 therefore corresponds to a circular line with the inner diameter Dᵢ of the first ring element 19, and the outer contour 24 of the second ring element 20 corresponds to a circle with the outer diameter dₐ of the second ring element 20. As illustrated for example in FIG. 2, the inner diameter Dᵢ, in the example, is selected to be greater than the outer diameter dₐ. In the example, the ring grooves 21, 22, in a view along the longitudinal central axis L (it being possible in this respect to make reference to a view of a projection onto a common plane of reference), are arranged so as to be concentric with one another. In this view, the inner contour 23, along its entire circumference leading around the longitudinal central axis L, is spaced apart from the outer contour 24 of the second ring element 20 with a constant spacing “a” perpendicular to the circumferential direction U.

In the example, the ring elements 19, 20 are rubber rings which are arranged in the ring grooves 21, 22. A cross-sectional diameter d of the ring elements 19, 20 is selected to be slightly larger than the depth t of the two ring grooves 21, 22. It follows from this that, if the gap 18 shown in FIG. 4 is present, the deformable ring elements 19, 20 project axially, that is to say in a direction along the longitudinal central axis L, beyond the armature stop surface 15 in the direction to the pole piece 11. The axial protrusion, which is the same for both ring elements 19, 20 in the example, is denoted in the figures by x. By comparison, FIG. 2 shows that, if the armature 10 bears against the pole piece 11, that is to say the gap 18 has disappeared, the ring elements 19, 20 have been pushed into the ring grooves 21, 22 such that there is no longer a protrusion x.

If, proceeding from the position shown in FIG. 4, the armature 10 is moved into the position shown in FIG. 2 in order to open the fluid valve, those portions of the ring elements 19, 20 which project beyond the armature stop surface 15 come into contact with the pole piece stop surface 17. In the process, the armature stop surface 15, the pole piece stop surface 17 and the ring elements 19, 20 enclose a fluid volume above the ring surface denoted by A. In a manner dependent on the sealing action generated by the ring elements 19, 20, the fluid volume, which acts as a cushion, is compressed upon a further approach of the armature 10 to the pole piece 11, and the further approach is pneumatically damped. Furthermore, the deformation of the ring elements 19, 20 also uses up energy, which likewise slows the approach. In the example, the armature stop surface 15 and the pole piece stop surface 17 are each of planar form and extend perpendicular to the longitudinal central axis L. The ring grooves 21, 22 are recessed into the armature 10 proceeding from the armature stop surface 15.

FIG. 1 illustrates that, with respect to a valve longitudinal direction VL, the pole piece 11 is arranged between the armature 10 and the fluid inlet 3 such that the armature stop surface 15 and the pole piece stop surface 17 limit axial movement of the valve needle 7 in a direction directed to the fluid inlet 3. Here, the first valve assembly 5 has a valve seat 25 which is coupled axially to the valve housing 2 and which limits axial movement of the valve needle 7 in a direction directed away from the fluid inlet 3. The first valve assembly 5 is thus of the so-called inwardly opening type. The first valve assembly 5 moreover has a restoring spring 26; in the example, it is a cylindrical compression spring. Its first longitudinal spring end 26 is supported indirectly against the valve housing 2 in the direction to the fluid inlet. The second longitudinal spring end 28 is supported against the valve needle 7 in the direction to the fluid outlet 4, wherein the restoring spring 26 is installed in a preloaded, that is to say compressed, state. The restoring spring 26 thus transmits to the valve needle 7 a spring force acting in the direction to the fluid outlet 4.

In the example embodiment shown in FIG. 1, the fluid valve 1 includes a second valve assembly 6. The latter, with respect to the fluid passage direction FD, is arranged downstream of the first valve assembly 5. A fluid outlet region 29 of the first valve assembly 5 is directly fluidically connected to a fluid inlet region 30 of the second valve assembly 6. The second valve assembly 6 includes a separate valve needle 31 and a separate restoring spring 32. The valve needle 31 is movable from a closed position into an open position along a cavity 33 in the valve housing 2 along the longitudinal central axis L counter to the spring force of the restoring spring 32. In the closed position, the tip 34 of the valve needle 31 interacts sealingly with the mouth of the fluid outlet 4. In the open position, the tip 34 protrudes slightly out of the mouth, whereby the sealing action is eliminated. The second valve assembly 6 therefore corresponds to the so-called outwardly opening valve type.

The functioning of the fluid valve 1 shown in FIGS. 1 to 4 will now be described. If the closed valve state is considered first, then the coil 12 is switched into a deenergized state. Consequently, owing to the restoring spring 26, the armature 10 is in the position shown in FIG. 4. The first valve assembly 5 is closed. Accordingly, no fluid can pass into the fluid inlet region 30 from the direction of the fluid inlet 3. Consequently, the restoring spring 32 causes the second valve assembly 6 to be closed too.

If, proceeding from this closed state, an electric current flows through the coil 12, the armature 10, as a consequence of the resulting electromagnetic force, is attracted by the pole piece 11 and, since the electromagnetic force is larger than the force of the restoring spring 26, is moved into the position shown in FIG. 2. In this way, the valve needle 7 is also moved axially, whereby its spherical longitudinal end is lifted off from the valve seat 25. The first valve assembly 5 is thus opened. Fluid flows into the fluid inlet region 30 through the passage formed between the valve seat 25 and the valve needle 7. In this way, a perforated pressure plate 35, which is connected fixedly to the valve needle 31, is subjected to fluid pressure in the direction to the fluid outlet 4. As soon as the resulting force exceeds the force of the restoring spring 32 that acts in the opposite direction, the valve needle 31 is moved in a manner directed away from the fluid inlet 3 and the second valve assembly 6 is thus also opened. It is noted that, in the figures shown, not all the passage ducts for fluid that are present are included in the illustrations.

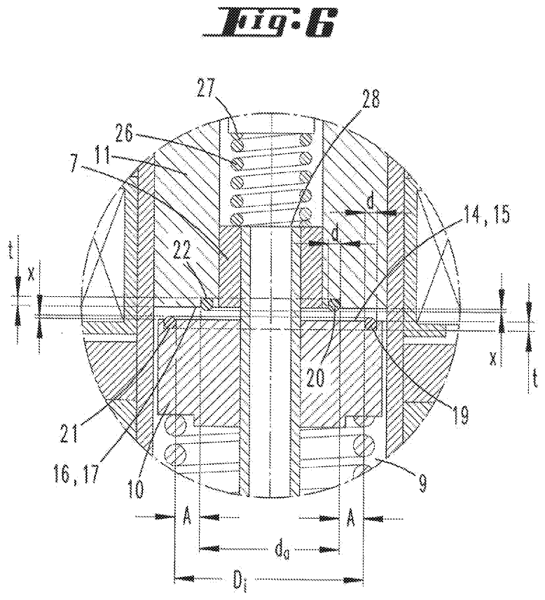

FIG. 5 shows, in an illustration comparable to FIG. 4, a detail of a fluid valve 1 as per a second example embodiment. The difference from FIG. 4 is in the position of the deformable ring elements 19, 20. The first ring groove 21 and the second ring groove 22 are formed on the pole piece stop side 16 proceeding from the pole piece stop surface 17. With regard to the effects and advantages, reference is made to the description of the first example embodiment.

FIG. 6 shows, in an illustration comparable to FIGS. 4 and 5, a detail of a fluid valve 1 as per a third example embodiment. There, the arrangement of the deformable ring elements 19, 20 is again different. In the example of FIG. 6, the first ring groove 21 is formed on the armature stop side 14 proceeding from the armature stop surface 15, and the second ring groove 22 is formed on the pole piece stop side 16 proceeding from the pole piece stop surface 17. The above-described effects and advantages are also achieved by means of such a configuration.

All the disclosed features are not insignificant to the operation of the described fluid valve, either individually or in combination with one another. The example embodiments have been described herein in an illustrative manner, and it is to be understood that the terminology which has been used is intended to be in the nature of words of description rather than of limitation. Obviously, many modifications and variations of the invention are possible in light of the above teachings. The description above is merely exemplary in nature and, thus, variations may be made thereto without departing from the spirit and scope of the invention as defined in the appended claims.

1. A fluid valve, comprising:
a valve housing extending from a fluid inlet to a fluid outlet along a longitudinal central axis and comprises at least one first valve assembly, wherein the first valve assembly comprises
a valve needle,
an electromagnetic actuating device, wherein the valve needle is movable in a cavity of the valve housing along the longitudinal central axis, wherein the electromagnetic actuating device has an armature, which is coupled to the valve needle, and a pole piece, which is coupled to the valve housing, wherein the armature has on an armature stop side which is opposite the pole piece an armature stop surface, and the pole piece has on a pole piece stop side which is opposite the armature a pole piece stop surface,
a deformable first ring element, and
a deformable second ring element between the armature stop side and the pole piece stop side, and in a view along the longitudinal central axis, an inner contour of the first ring element extends outside an outer contour of the second ring element.

2. The fluid valve according to claim 1, wherein the fluid valve is a gas injection valve, wherein, for damping a movement of the armature stop surface in a direction toward the pole piece stop surface, a gas cushion is enclosed between the armature stop surface and the pole piece stop surface by the first and second ring elements, and wherein the gas cushion is delimited in a radial direction by the first ring element and the second ring element.

3. The fluid valve as claimed claim 1, wherein, in a view along the longitudinal central axis, the inner contour of the first ring element is spaced apart from the outer contour of the second ring element perpendicular to a circumferential direction.

4. The fluid valve of claim 1, wherein, in a view along the longitudinal central axis, the inner contour of the first ring element, along an entire circumference leading around the longitudinal central axis, first ring element is spaced apart from the outer counter of the second ring element perpendicular to a circumferential direction.

5. The fluid valve as claimed in claim 1, wherein the first and second ring elements are formed by a first sealing lip and a second sealing lip of an elastomer ring, respectively, wherein both sealing lips are projections of the elastomer ring that point in a direction of the armature stop surface or in a direction of the pole piece stop surface, the first sealing lip extends around the second sealing lip, and the elastomer ring, is received in a ring groove of the armature or of the pole piece.

6. The fluid valve as claimed in claim 5, wherein the first sealing lip extends around the second sealing lip, and the elastomer ring, on a side thereof facing away from the sealing lips, is received in a ring groove of the armature or of the pole piece.

7. The fluid valve as claimed in claim 1, wherein on the armature stop side or on the pole piece stop side, a first ring groove is formed in the armature or in the pole piece, in which first ring groove the first ring element is arranged, and on the armature stop side or on the pole piece stop side, a second ring groove is formed in the armature or in the pole piece, in which second ring groove the second ring element is arranged, wherein, if a gap is formed between the armature stop surface and the pole piece stop surface, the first ring element projects axially from the first ring groove and the second ring element projects axially from the second ring groove.

8. The fluid valve as claimed in claim 7, wherein the first ring groove and the second ring groove, in a view along the longitudinal central axis, are arranged so as to be concentric with one another.

9. The fluid valve as claimed in claim 7, wherein
at least one of the first ring groove and the second ring groove is circular, polygonal or multi-cornered in shape, and/or
the first ring element is placed or injected into the first ring groove or is fastened therein, and/or
the second ring element is placed or injected into the second ring groove or is fastened therein.

10. The fluid valve as claimed in claim 1, wherein the first ring element and the second ring element are produced from elastically deformable material.

11. The fluid valve as claimed in claim 1, wherein at least one of the armature stop surface and the pole piece stop surface extends perpendicular to the longitudinal central axis.

12. The fluid valve as claimed in claim 1, wherein, with respect to a valve longitudinal direction, the pole piece is arranged between the armature and the fluid inlet such that the armature stop surface and the pole piece stop surface limit axial movement of the valve needle in a direction directed to the fluid inlet.

13. The fluid valve as claimed in claim 1, wherein the first valve assembly has a valve seat which is coupled axially to the valve housing or is formed on the valve housing and which limits axial movement of the valve needle in a direction directed away from the fluid inlet.

14. The fluid valve as claimed in claim 1, wherein the first valve assembly has a restoring spring, one of whose longitudinal spring ends is supported directly or indirectly against the valve housing, and whose second longitudinal spring end is supported directly or indirectly against the valve needle, with the result that the restoring spring subjects the valve needle to spring force in a direction towards the fluid outlet.

15. The fluid valve as claimed in claim 1, wherein the fluid valve comprises a second valve assembly, which, with respect to a fluid passage direction of the fluid valve, is arranged downstream of the first valve assembly, a fluid outlet region of the first valve assembly is fluidically connected to a fluid inlet region of the second valve assembly, and the second valve assembly comprises a separate valve needle and a separate restoring spring, wherein the valve needle of the second valve assembly is movable, from a closed position into an open position, in a cavity of the valve housing along the longitudinal central axis counter to a spring force of the restoring spring of the second valve assembly.

16. A method for controlling a supply of fluid, into a combustion chamber of an internal combustion engine, a fluid valve as claimed in claim 1 is provided, and wherein the electromagnetic actuating device is activated such that the armature, for opening the fluid valve, is attracted in an electromagnetic manner by the pole piece, whereby the first deformable ring element and the second deformable ring element are increasingly deformed.

17. The method as claimed in claim 16, wherein the armature is attracted by the pole piece until the armature stop surface abuts against the pole piece stop surface.
